(19) United States
(12) Patent Application Publication
(10) Pub. No.: US 2024/0390832 A1
(43) Pub. Date: Nov. 28, 2024

(54) AIR FILTER WITH FILTERED CAP

(71) Applicant: K&N Engineering, Inc., Riverside, CA (US)

(72) Inventor: Jere James Wall, Riverside, CA (US)

(73) Assignee: K&N Engineering, Inc., Riverside, CA (US)

(21) Appl. No.: 18/625,512

(22) Filed: Apr. 3, 2024

Related U.S. Application Data
(60) Provisional application No. 63/456,890, filed on Apr. 4, 2023.

(51) Int. Cl. B01D 46/58; B01D 46/00; B01D 46/10; B01D 46/24; F02M 35/024

(52) U.S. Cl. CPC B01D 46/58; B01D 46/0035; B01D 46/10; B01D 46/24; F02M 35/02408; F02M 35/0245; F02M 35/02466; B01D 2265/06; B01D 2267/40; B01D 2275/201; B01D 2275/202; B01D 2279/60

(57) ABSTRACT

An apparatus and methods are provided for a filtered cap air filter configured to be coupled with an air intake system of an internal combustion engine. The filtered cap air filter comprises a filter medium that is retained between a base and a filtered cap. The filter medium and the filtered cap are fabricated to remove contaminants and particulate matter from an intake airstream. In some embodiments, the filter medium and filtered cap may be configured to be treated with a filter oil composition to enhance air cleaning properties of the filter media. Wire supports may be incorporated into the filter medium and filtered cap to provide additional strength and durability to the filtered cap air filter. The base includes a flange and an opening that form an airtight connection between the filtered cap air filter and an air intake duct of the air intake system.

### PRIORITY

This application claims the benefit of and priority to U.S. Provisional Application, entitled “Air Filter With Filtered Cap,” filed on Apr. 4, 2023, and having application Ser. No. 63/456,890, the entirety of said application being incorporated herein by reference.

### FIELD

Embodiments of the present disclosure generally relate to filtration devices. More specifically, embodiments of the disclosure relate to an apparatus and methods for an air filter that includes a cap comprising a filter medium for removing particulate matter from an airstream entering the air filter through a top region of the air filter.

### BACKGROUND

An air filter designed to remove particulate matter from an airstream generally is a device comprising fibrous materials. These fibrous materials may remove solid particulates such as dust, pollen, mold, and bacteria from the airstream. Air filters are used in applications where air quality is important, notably in building ventilation systems and with engines.

Air filters may be used in automobiles, trucks, tractors, locomotives, and other vehicles that use internal combustion engines. Air filters may be used with gasoline engines, diesel engines, or other engines that utilize fossil fuels or other combustible substances. Air filters may be used with engines in which combustion is intermittent, such as four-stroke and two-stroke piston engines, as well as other types of engines that take in air continuously so that a combustible substance may be burned. For example, air filters may be used with some gas turbines. Filters may also be used with air compressors or in other devices that take in air.

Filters may be made from pleated paper, foam, cotton, spun fiberglass, or other known filter materials. Generally, the air filters used with internal combustion engines and compressors tend to be comprised of either paper, foam, or cotton filters. Some filters use an oil bath. Air filters for internal combustion engines prevent abrasive particulate matter from entering the cylinders of the engine, where it would cause mechanical wear and oil contamination. In many fuel injected engines, a flat panel pleated paper filter element may be used. This filter is usually placed inside a plastic box connected to the throttle body with ductwork. Vehicles that use carburetors or throttle body fuel injection typically use a cylindrical air filter positioned above the carburetor or throttle body.

### SUMMARY

An apparatus and methods are provided for a filtered cap air filter configured to be coupled with an air intake system of an internal combustion engine. The filtered cap air filter comprises a filter medium that is retained between a base and a filtered cap. The filter medium and the filtered cap are fabricated to remove contaminants and particulate matter from an intake airstream. In some embodiments, the filter medium and filtered cap may be configured to be treated with a filter oil composition to enhance air cleaning properties of the filter media. Wire supports may be incorporated into the filter medium and filtered cap to provide additional strength and durability to the filtered cap air filter. The base includes a flange and an opening that form an airtight connection between the filtered cap air filter and an air intake duct of the air intake system.

In an exemplary embodiment, an air filter for an air intake system of an internal combustion engine comprises: a first filter medium for entrapping the particulate matter; a base for coupling with the air intake system; and a filtered cap comprising a second filter medium enclosing an interior cavity of the first filter medium.

In another exemplary embodiment, one or more of the first filter medium and the second filter medium are configured to receive a filter oil composition. In another exemplary embodiment, the first filter medium and the second filter medium are configured to be cleaned and reused. In another exemplary embodiment, the base and the filtered cap are joined to opposite ends of the first filter medium.

In another exemplary embodiment, the base and the filtered cap are molded onto and retain a first wire support disposed on an outer surface of the first filter medium. In another exemplary embodiment, the base and the filtered cap are molded onto and retain a second wire support disposed on an inner surface of the first filter medium. In another exemplary embodiment, the first wire support and the second wire support are co-pleated along with the first filter medium. In another exemplary embodiment, one or more of the first wire support and the second wire support comprise powder-coated aluminum screen wires.

In another exemplary embodiment, the filtered cap comprises a support ring surrounding the second filter medium. In another exemplary embodiment, the support ring comprises a rigid material that is suitable for retaining the second filter medium atop the air filter. In another exemplary embodiment, the support ring includes circumferentially disposed slots that are configured to allow material comprising a molding to better couple the filtered cap with the first filter medium. In another exemplary embodiment, the support ring is molded onto and retains the second filter medium.

In another exemplary embodiment, the support ring is molded onto and retains a first wire support disposed on an outer surface of the second filter medium. In another exemplary embodiment, the support ring is molded onto and retains a second wire support disposed on an inner surface of the second filter medium. In another exemplary embodiment, the first wire support and the second wire support are co-pleated with the second filter medium. In another exemplary embodiment, one or more of the first wire support and the second wire support comprise powder-coated aluminum screen wires.

In an exemplary embodiment, a method for an air filter for an air intake system of an internal combustion engine comprises: configuring a first filter medium for entrapping the particulate matter; forming a base for coupling with the air intake system; coupling the first filter medium with the base; configuring a filtered cap comprising a second filter medium; and enclosing an interior cavity of the first filter medium by way of the filtered cap.

In another exemplary embodiment, configuring the first filter medium includes configuring the first filter medium to receive a filter oil composition. In another exemplary embodiment, configuring the filtered cap includes configuring the second filter medium to receive a filter oil composition. In another exemplary embodiment, configuring the filtered cap includes surrounding the second filter medium with a support ring that can be coupled with the first filter medium.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates an isometric view of an exemplary embodiment of a filtered cap air filter, according to the present disclosure;

FIG. 2 illustrates a top view of an exemplary embodiment of a filtered cap air filter in accordance with the present disclosure;

FIG. 3 illustrates a cross-sectional view of the filtered cap air filter of FIG. 2, taken along line A-A, according to the present disclosure;

FIG. 4 illustrates a bottom view of an exemplary embodiment of a filtered cap air filter in accordance with the present disclosure;

FIG. 5 is a close-up view of an exemplary embodiment of a filtered cap comprising the filtered cap air filter of FIG. 3, taken within detail area B according to the present disclosure;

FIG. 6 is a close-up view of an exemplary embodiment of a base comprising the filtered cap air filter of FIG. 3, taken within detail area C in accordance with the present disclosure;

FIG. 7 illustrates an isometric view of an exemplary embodiment of a filtered cap configured for implementation in a filtered cap air filter in accordance with the present disclosure;

FIG. 8 illustrates a bottom view of an exemplary embodiment of a filtered cap provided for a filtered cap air filter, according to the present disclosure;

FIG. 9 illustrates a top view of an exemplary embodiment of a filtered cap provided for a filtered cap air filter in accordance with the present disclosure;

FIG. 10 illustrates a cross-sectional view of the filtered cap of FIG. 9, taken along line D-D, according to the present disclosure; and

FIG. 11 is a close-up view of the filtered cap of FIG. 10, taken within detail area E, in accordance with the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the filtered cap air filter and methods disclosed herein may be practiced without these specific details. In other instances, specific numeric references such as “first filter medium,” may be made. However, the specific numeric reference should not be interpreted as a literal sequential order but rather interpreted that the “first filtered medium” is different than a “second filtered medium.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an apparatus and methods for a filtered cap air filter configured to be coupled with an air intake system of an internal combustion engine. The filtered cap air filter comprises a filter medium that is retained between a base and a filtered cap. The filter medium and the filtered cap are fabricated to remove contaminants and particulate matter from an intake airstream. In some embodiments, the filter medium and filtered cap may be configured to be treated with a filter oil composition to enhance air cleaning properties of the filter media. Wire supports may be incorporated into the filter medium and filtered cap to provide additional strength and durability to the filtered cap air filter. The base includes a flange and an opening that form an airtight connection between the filtered cap air filter and an air intake duct of the air intake system.

Although embodiments of the invention may be described and illustrated herein in terms of a cone-shaped air filter, it should be understood that embodiments of this invention are not limited to the exact shape illustrated, but rather may include a wide variety of generally enclosed shapes, such as cylindrical, circular, oval, round, curved, conical, or any other closed perimeter shape, that provide a relatively large surface area in a given volume of the filter. Moreover, embodiments as described herein are not limited to use as internal combustion engine filters, but rather may have applicability in other filtration systems in which a large volume of air requires treatment.

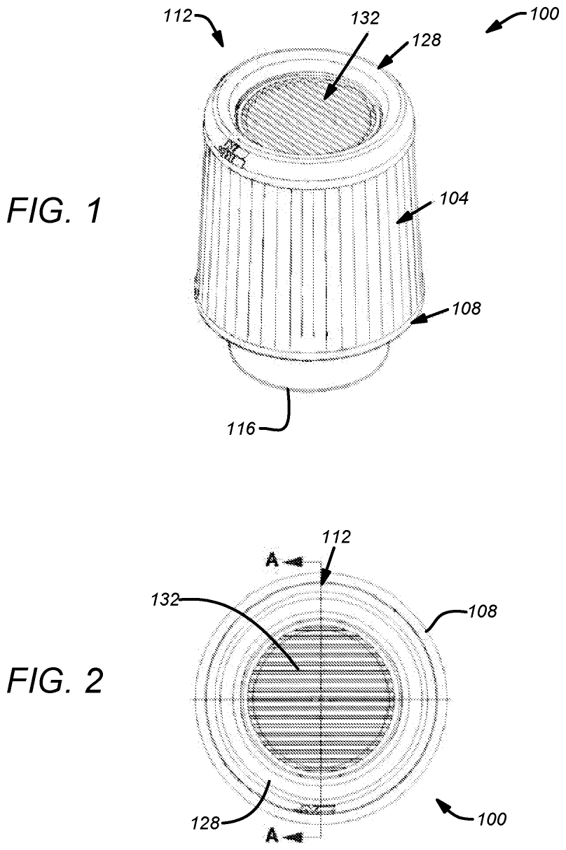

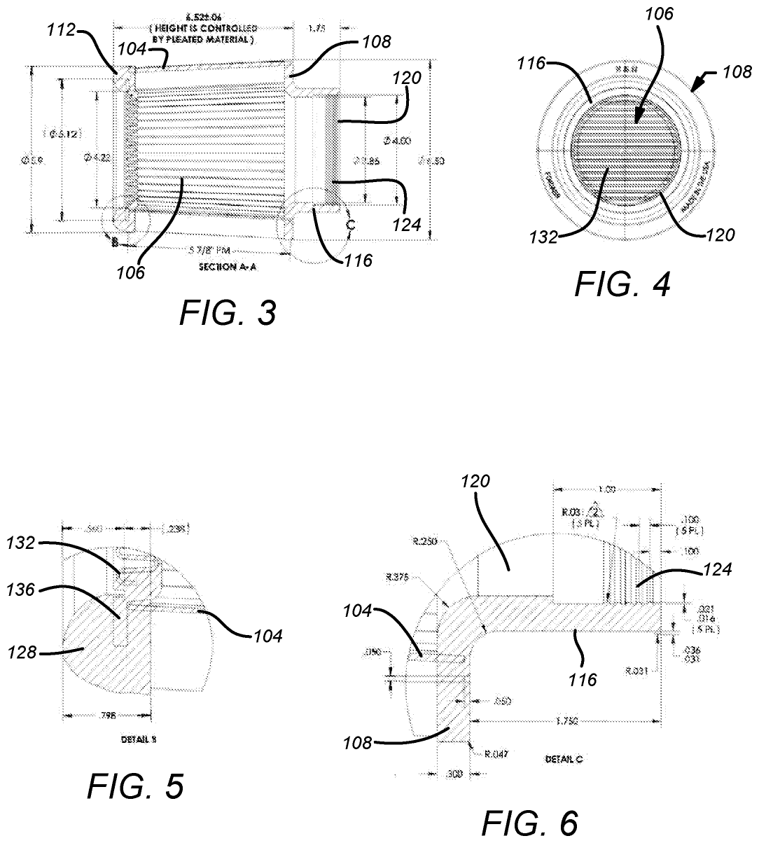

FIG. 1 illustrates an isometric view of an exemplary embodiment of a filtered cap air filter 100 configured for use within an air intake system of an internal combustion engine. It is contemplated that the air intake system may be either of a closed variety or an open intake system. The filtered cap air filter 100 is comprised of a filter medium 104 disposed between a base 108 and a filtered cap 112. The filtered cap air filter 100 is configured to be coupled with an air intake duct comprising the air intake system, such that an intake airstream is drawn through the filter medium 104 into an interior 106 (see FIG. 3) of the filtered cap air filter 100, and drawn into the air intake duct to the internal combustion engine. The filter medium 104 is configured to remove contaminants and particulate matter from the intake airstream that is drawn into the air intake duct. The filter medium 104 is a generally cone-shaped member having a diameter that tapers as a function of distance from the base 108 along the filter medium. The filtered cap 112 serves to remove particulate matter and other contaminants from a portion of the intake airstream entering the interior of the air filter 100 through the top-most portion of the air filter. It is contemplated that the filtered cap 112 may include a rigid material suitable for withstanding the temperature and pressure encountered within the air intake system, as described herein.

In the embodiment of the filtered cap air filter 100 illustrated in FIGS. 1-2, the base 108 has a diameter that is greater than the diameter of the filtered cap 112. In some embodiments, however, the diameter of the base 108 may be substantially equal to the diameter of the filtered cap 112. It should be understood that the filtered cap air filter 100 is not limited to the exact shape illustrated in FIGS. 1-2, but rather may the filtered cap air filter 100 may include a wide variety of generally cylindrical, circular, oval, round, curved, or other closed perimeter shapes, that provide a relatively large surface area of the filter medium 104. Further, it will be appreciated that the specific configuration of the filtered cap air filter 100 depends upon the particular make and model of the engine for which the filtered cap air filter is to be utilized, and thus a wide variety of heights and diameters of the filter medium 104 may be incorporated into the filtered cap air filter 100 without straying beyond the scope of the present disclosure.

The base 108 generally is configured to support the filtered cap air filter 100 and provide an interface between the interior 106 (see FIG. 3) of the filtered cap air filter 100 and an air intake duct of an internal combustion engine. Any of a variety of fasteners (not shown) may be used to affix the filter medium 104 to the base 108. In some embodiments, the base 108 may be molded to a wire support of the filter medium 104. In some embodiments, the base 108 may be crimped such that it folds onto and retains the wire support and the filter medium 104 of the filtered cap air filter 100. It will be appreciated by those skilled in the art that affixing the filter medium 104 to the base 108 generally renders the filter medium 104 irremovable from the filtered cap air filter 100. As such, it is contemplated that a practitioner may periodically clean the filtered cap air filter 100, as discussed herein.

As best shown in FIGS. 3 and 6, the base 108 includes a flange 116 that provides an opening 120 to the interior 106 (see FIG. 4) of the filtered cap air filter 100. As will be appreciate, the flange 116 and the opening 120 are configured to receive an air intake duct of an internal combustion engine. In some embodiments, the flange 116 may be fastened onto the air intake duct by way of a clamp (not shown) or other suitable device. Further, the opening 120 may include any of various surface features 124 configured to aid in establishing an airtight union between the flange 116 and the air intake duct.

The filtered cap 112 may be affixed to the filter medium 104 by way of any of a variety of fasteners (not shown), or suitable adhesives. In the illustrated embodiment, the filtered cap 112 is affixed to the filter medium 104 by way of a molding 128, as best shown in FIGS. 3 and 5. In some embodiments, wherein the filter medium 104 includes a wire support, the filtered cap 112 may be molded onto the filter medium 104 and the wire support. In some embodiments, the filtered cap 112 may be crimped around its peripheral edge such that it folds onto and retains the wire support and the filter medium 104 of the filtered cap air filter 100. Any of various fastening means may be practiced for attaching the filter medium 104 and the wire support to the filtered cap 112, without limitation.

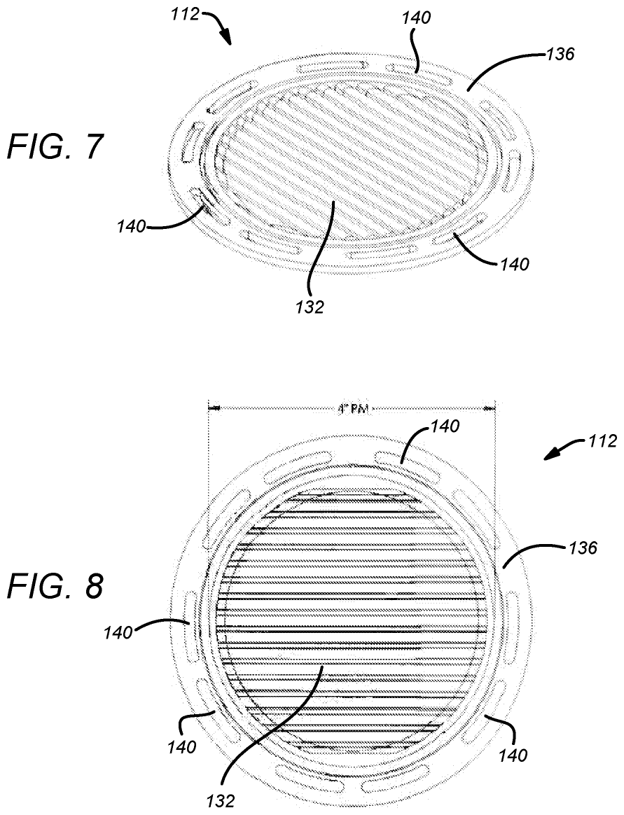

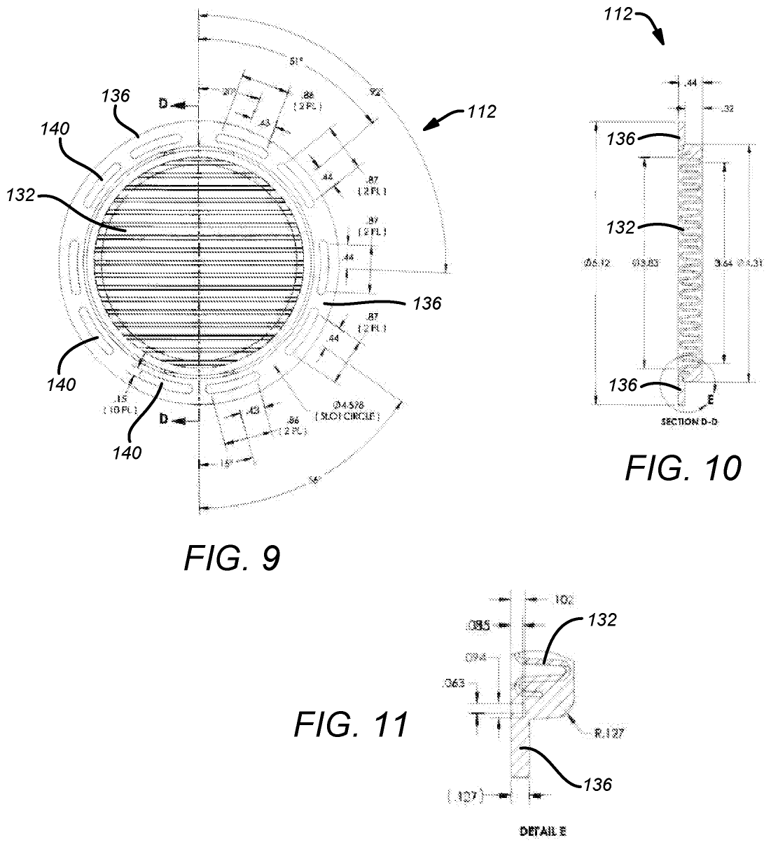

As best shown in FIGS. 7-11, the filtered cap 112 comprises a filter medium 132 that is surrounded by a support ring 136. The ring 136 preferably is made of a rigid material capable of supporting the filter medium 132 during operation of the filtered cap air filter 100. As shown in FIGS. 7-8, the ring 136 includes several slots 140 disposed around a circumference of the ring 136. The slots 140 are configured to allow material comprising the molding 128 to better couple with the ring 136 so as to provide a relatively strong union between the filtered cap 112 and the filter medium 104, as described herein.

Any of a variety of devices may be used to couple the filter medium 132 to the support ring 136. As best shown in FIGS. 10-11, the material comprising the support ring 132 may be molded onto the filter medium 132. In some embodiments, the support ring 136 may be molded onto a wire support that is coupled with the filter medium 132. In some embodiments, the support ring 136 may be crimped such that it folds onto and retains the wire support and the filter medium 132 of the filtered cap 112. As will be appreciated, affixing the filter medium 132 to the support ring 136, and thus the filtered cap air filter 100, generally renders the filter medium 132 irremovable from the filtered cap air filter 100. As such, it is contemplated that a practitioner may periodically clean the filtered cap 112 during cleaning the filtered cap air filter 100, as discussed herein.

In general, the filter media 104, 132 provide surface areas through which to pass the intake airstream and entrap particulates and other contaminates flowing with the intake airstream. The filter media 104, 132 may be comprised of paper, foam, cotton, spun fiberglass, or other known filter materials, woven or non-woven materials, synthetic or natural, or any combination thereof. The filter media 104, 132 may be pleated, or otherwise shaped, or contoured so as to increase the total surface area for passing the intake airstream to be cleaned. For example, in the illustrated embodiment, the filter medium 104 comprises about 50 pleats of 7/16″×3½″ filter material, while the filter medium 132 comprises about 17 pleats of 7/16″×4¼″ filter material. It should be understood that the filter media 104, 132 may comprise any suitable filter material, without limitation.

As mentioned above, some embodiments of the filtered cap air filter 100 may comprise wire supports that are incorporated into either or both of the filter media 104, 132. Incorporating wire supports into the filter media 104, 132 provides additional strength and durability to the filtered cap air filter 100. For example, in some embodiments, the filter media 104, 132 may be positioned between wire supports and one or more layers of a reinforcing material. The wire supports may comprise wire screens positioned on outer surfaces and inner surfaces of the filter media 104, 132. In some embodiments, either or both of the filter media 104, 132 may be comprised of 4 to 6 layers of cotton gauze that are sandwiched between two epoxy-coated aluminum wire screens. It is contemplated that the wire screens may be co-pleated along with the filter media 104, 132 so as to reinforce the filtered cap air filter 100.

Moreover, the cotton gauze may be advantageously treated with a suitably formulated filter oil composition that causes tackiness throughout microscopic strands comprising the filter media 104, 132. The nature of the cotton allows high volumes of airflow, and when combined with the tackiness of the filter oil composition creates a powerful filtering medium which ensures a high degree of air filtration. Further details about components comprising the filter media 104, 132, as well as details about the filter oil composition, are disclosed in U.S. Pat. No. 10,359,010 B2, entitled “Air Box With Integrated Filter Media,” granted on Jul. 23, 2019, and U.S. Pat. No. 10,294,897 B2, entitled “Filter Oil Formulation,” granted on May 21, 2019, the entirety of each of which is incorporated herein by reference.

It is contemplated that a practitioner of the filtered cap air filter 100 may periodically clean the filter media 104, 132 rather than discarding the entire filtered cap air filter 100, as is done with conventional air filters. In one embodiment, a cleaning method may be comprised of accessing the filtered cap air filter 100 within an air intake system and then loosening a clamp of other device that fastens the flange 116 onto an air intake duct. The filtered cap air filter 100 may then be removed from the air intake system. The practitioner may clean the filtered cap air filter 100 by inserting a water hose through the opening 120 into the interior 106 and then spraying water so as to flush contaminants from the filter media 104, 132. In some embodiments, the method for cleaning the filtered cap air filter 100 may be comprise utilizing a high-pressure air hose in lieu of the water hose. In some embodiments, the method for cleaning the filtered cap air filter 100 may be comprised of spraying water onto the exterior of the filter media 104, 132, such that the water and contaminants are flushed directly from the exterior of the filter media 104, 132. It is contemplated that any water and contaminants that are forced through the filter media 104, 132 may exit the interior 106 through the opening 120. Other cleaning methods will be apparent to those skilled in the art without deviating from the spirit and scope of the present disclosure.

While the filtered cap air filter and methods have been described in terms of particular variations and illustrative figures, those of ordinary skill in the art will recognize that the filtered cap air filter is not limited to the variations or figures described. In addition, where methods and steps described above indicate certain events occurring in certain order, those of ordinary skill in the art will recognize that the ordering of certain steps may be modified and that such modifications are in accordance with the variations of the filtered cap air filter. Additionally, certain of the steps may be performed concurrently in a parallel process, when possible, as well as performed sequentially as described above. To the extent there are variations of the filtered cap air filter, which are within the spirit of the disclosure or equivalent to the filtered cap air filter found in the claims, it is the intent that this patent will cover those variations as well. Therefore, the present disclosure is to be understood as not limited by the specific embodiments described herein, but only by scope of the appended claims.

What is claimed is:

1. An air filter for an air intake system of an internal combustion engine, comprising:
a first filter medium for entrapping the particulate matter;
a base for coupling with the air intake system; and
a filtered cap comprising a second filter medium enclosing an interior cavity of the first filter medium.

2. The air filter of claim 1, wherein one or more of the first filter medium and the second filter medium are configured to receive a filter oil composition.

3. The air filter of claim 1, wherein the first filter medium and the second filter medium are configured to be cleaned and reused.

4. The air filter of claim 1, wherein the base and the filtered cap are joined to opposite ends of the first filter medium.

5. The air filter of claim 4, wherein the base and the filtered cap are molded onto and retain a first wire support disposed on an outer surface of the first filter medium.

6. The air filter of claim 5, wherein the base and the filtered cap are molded onto and retain a second wire support disposed on an inner surface of the first filter medium.

7. The air filter of claim 6, wherein the first wire support and the second wire support are co-pleated along with the first filter medium.

8. The air filter of claim 7, wherein one or more of the first wire support and the second wire support comprise powder-coated aluminum screen wires.

9. The air filter of claim 1, wherein the filtered cap comprises a support ring surrounding the second filter medium.

10. The air filter of claim 9, wherein the support ring comprises a rigid material that is suitable for retaining the second filter medium atop the air filter.

11. The air filter of claim 10, wherein the support ring includes circumferentially disposed slots that are configured to allow material comprising a molding to better couple the filtered cap with the first filter medium.

12. The air filter of claim 10, wherein the support ring is molded onto and retains the second filter medium.

13. The air filter of claim 12, wherein the support ring is molded onto and retains a first wire support disposed on an outer surface of the second filter medium.

14. The air filter of claim 13, wherein the support ring is molded onto and retains a second wire support disposed on an inner surface of the second filter medium.

15. The air filter of claim 14, wherein the first wire support and the second wire support are co-pleated with the second filter medium.

16. The air filter of claim 15, wherein one or more of the first wire support and the second wire support comprise powder-coated aluminum screen wires.

17. A method for an air filter for an air intake system of an internal combustion engine, comprising:
configuring a first filter medium for entrapping the particulate matter;
forming a base for coupling with the air intake system;
coupling the first filter medium with the base;
configuring a filtered cap comprising a second filter medium; and
enclosing an interior cavity of the first filter medium by way of the filtered cap.

18. The method of claim 17, wherein configuring the first filter medium includes configuring the first filter medium to receive a filter oil composition.

19. The method of claim 17, wherein configuring the filtered cap includes configuring the second filter medium to receive a filter oil composition.

20. The method of claim 17, wherein configuring the filtered cap includes surrounding the second filter medium with a support ring that can be coupled with the first filter medium.
